(19) United States
(12) Patent Application Publication
(10) Pub. No.: US 2022/0358506 A1
(43) Pub. Date: Nov. 10, 2022

(54) METHODS AND SYSTEMS FOR RESOLVING AUTOMATED TELLER MACHINE ERRORS

(71) Applicant: Capital One Services, LLC, McLean, VA (US)

(72) Inventors: Trevor CONNOLLY, Brooklyn, NY (US); Matthew APPLEBY, Washington, DC (US); Kristi CANDELA, Sunnyside, NY (US); Danielle SIMPSON, Manassas, VA (US); Amy WEDMORE, Washington, DC (US); Roberto RODRIGUEZ, Falls Church, VA (US)

(73) Assignee: Capital One Services, LLC, McLean, VA (US)

(21) Appl. No.: 17/314,516

(22) Filed: May 7, 2021

(51) Int. Cl. G06Q 20/40; G06Q 20/10; G06Q 40/02

(52) U.S. Cl. CPC G06Q 20/4016; G06Q 20/1085; G06Q 40/02

(57) ABSTRACT

Disclosed are methods, systems, and non-transitory computer-readable medium for resolving automated teller machine (ATM) errors. For instance, the method may include receiving error information indicative of the error; collecting interaction information, including user information and terminal information, related to the interaction at the terminal; and generating a claim that includes an identification of the claim, the error information, and the interaction information. The method may further include transmitting an indication of the claim to a device associated with the person; analyzing the claim by using a risk exposure model; and selecting, using the analysis of the claim, an exposure value for the claim. The method may continue to determining, based at least in part on the exposure value, whether a claim restitution should be completed; and transmitting, to the device associated with the person, the determination of whether the claim restitution should be completed.

### TECHNICAL FIELD

Various embodiments of the present disclosure relate generally to methods and systems for resolving automated teller machine (ATM) errors and, more particularly, to methods and systems for generating a claim related to an ATM error, analyzing the claim, and determining whether restitution should be granted.

### BACKGROUND

While most ATMs are able to handle large volumes of interactions (e.g., transactions) without issue, occasionally errors occur. These errors may be mechanical, electrical, or both, and may be the result of wear, damage, malfunction, poor maintenance, power failures, or a number of other conditions. Whatever the cause, ATM interactions involve one or more assets and errors can result in users being given or credited with too much, or not enough assets. In either event, it is in the interest of all parties to resolve the error and ensure that the user promptly ends up with the correct balance. The delay and inaccuracies in resolving those errors can cost time and resources, as well as adversely impacting user service.

The present disclosure is directed to overcoming one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, methods and systems for resolving ATM interaction errors are disclosed. The methods and systems may provide for faster, and more accurate determinations with regard to resolving ATM errors.

For instance, a method may include receiving error information indicative of the error; collecting interaction information, including user information and terminal information, related to the interaction at the terminal; and generating a claim that includes an identification of the claim, the error information, and the interaction information. The method may further include transmitting an indication of the claim to a device associated with the person; analyzing the claim by using a risk exposure model; and selecting, using the analysis of the claim, an exposure value for the claim. The method may continue to determining, based at least in part on the exposure value, whether a claim restitution should be completed; and transmitting, to the device associated with the person, the determination of whether the claim restitution should be completed.

A system may include a memory storing instructions; and a processor executing the instructions to perform a process. The process may include receiving error information indicative of the error; collecting interaction information relating to the interaction at the terminal, the interaction information including user information and terminal information; generating a claim that includes an identification of the claim, the error information, and the interaction information; and transmitting an indication of the claim to a device associated with the person. The process may further include analyzing the claim by using a risk exposure model; selecting, using the analysis of the claim, an exposure value for the claim; determining, based at least in part on the exposure value, whether a claim restitution should be completed; and transmitting, to the device associated with the person, the determination of whether the claim restitution should be completed.

A non-transitory computer-readable medium may store instructions that, when executed by a processor, cause the processor to perform a method. The method may include receiving error information indicative of an error in an interaction between a person and a terminal, wherein the error information is generated by the terminal in response to a malfunction; collecting interaction information relating to the interaction at the terminal, the interaction information including user information and terminal information, and wherein at least a first portion of the interaction information is collected from the terminal and at least a second portion of the interaction information is collected from a server associated with an institution related to the interaction; generating a claim that includes an identification of the claim, the error information, and the interaction information; and transmitting an indication of the claim to a device associated with the person. The method may further include analyzing the claim by using a risk exposure model, wherein the analysis of the claim includes evaluating one or more elements of the claim, wherein the one or more elements of the claim include an amount in dispute, an interaction history associated with the person, and the error information; selecting, using the analysis of the claim, an exposure value for the claim; determining, based at least in part on the exposure value, whether a claim restitution should be completed; and transmitting, to the device associated with the person, the determination of whether the claim restitution should be completed.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary block diagram of a system environment for ATM error resolution, according to one or more embodiments.

FIG. 2 depicts a flowchart of an exemplary method of resolving ATM transaction errors, according to one or more embodiments.

FIG. 3 depicts a flowchart for an exemplary method of transmitting an indication of a claim, according to one or more embodiments.

FIG. 4 depicts a flowchart for an exemplary process of determining whether a claim restitution should be completed, according to one or more embodiments.

FIG. 5 depicts an exemplary system that may execute techniques presented herein.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In general, the present disclosure is directed to methods and systems for resolving ATM transaction errors by generating a claim, analyzing that claim, and determining whether a claim restitution should be completed. In particular, a method of the present disclosure may begin with the receipt of error information related to an ATM transaction from, for example and not limitation, an ATM or user report. For example, during a user interaction at an ATM, the user may deposit resources while the ATM may indicate that a different, incorrect amount of resources have been deposited. This could be the result of an ATM error that the ATM recognizes or one that it doesn't recognize. In the event of a recognized ATM error, error information may come from the ATM directly, or an error code or the like may be displayed to a user. In the event that the user notices the error, error information may be provided by the user via a mobile application, website, and/or phone call. After collecting information from available sources, such as the ATM and/or a database associated with a banking institution, a claim may be generated and a notification may be sent to the user. Upon conducting an analysis of the claim, a risk exposure model may be used to evaluate the claim information and compare it to, for example, previously adjudicated claims relevant to that ATM or that type of ATM. The resulting exposure value for the claim may then be used to determine if the user is or is not likely to be entitled to additional credit to correct the error. This initial analysis may be able to promptly credit the user as restitution for the error, either on a provisional or non-provisional basis, leaving the user with the correct amount of resources.

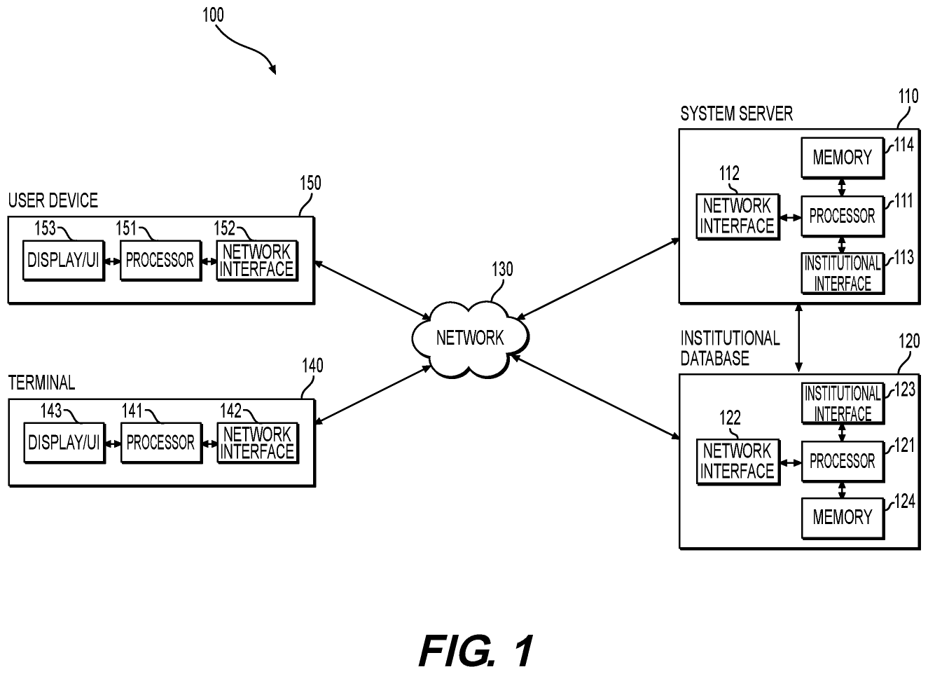

FIG. 1 depicts an exemplary system environment 100 that may be utilized with techniques presented herein. For example, the environment may include system server 110 which may receive the error information and conduct the claim analysis. System server 110 may include a processor 111 to execute instructions, and a network interface 112 with which to communicate with other elements in system environment 100. System server 110 may also include an institutional interface 113, in addition to or in combination with network interface 112, which may enable system server 110 to communicate with a secure institutional database 120. Instructions to be executed by processor 111 may be stored in memory 114.

Institutional database 120 may be, for example, a secure server or other system associated with a financial institution, with which the ATM and/or account being accessed may be affiliated, and on which user and account data may be stored. A processor 121 may execute instructions stored in a memory 124 in order to allow institutional database 120 to receive and store user and account data received via a network interface 122 and/or an institutional interface 123.

Network interface 112 of system server 110 and network interface 122 of institutional database 120 may communicate with each other and/or other elements of the system environment 100 via network 130. Network 130 may be implemented as, for example, the Internet, a wireless network, a wired network (e.g., Ethernet), a local area network (LAN), a Wide Area Network (WANs), Bluetooth, Near Field Communication (NFC), or any other type of network or combination of networks that provides communications between one or more components of the system environment 100. In some embodiments, the network 130 may be implemented using a suitable communication protocol or combination of protocols such as a wired or wireless Internet connection in combination with a cellular data network.

Network 130 may provide system server 110 and institutional database 120 with access to a terminal 140 and/or a user device 150. Terminal 140, such as an ATM or other access point, may include a processor 141, a network interface 142, and a display/user interface (UI) 143. Processor 141 may enable terminal 140 to conduct interactions with users, and provide data regarding those interactions, via network 130 and network interface 142, to system server 110 and/or institutional database 120. User interface 143 may facilitate transactions with users seeking to, for example, withdraw or deposit cash or checks.

User device 150 can be, for example, a computer, smartphone, tablet, or other network-accessible computing device, and may include a processor 151, a network interface 152, and a display/UI 153. User device 150 may be capable of allowing a user to receive messages, such as those received from institutions (e.g., an institution associated with institutional database 120), and to transmit responses in accordance with user input. Processor 151 may execute instructions to perform functions including, for example, presenting a user with information received from system server 110 or transmitting messages to system server 110.

Although depicted as separate components in FIG. 1, it should be understood that a component or portion of a component may, in some embodiments, be integrated with or incorporated into one or more other components. For example, the terminal 140 may be associated with the institution such that is may be considered to be a portion of the institutional database 120. Further, while a single user device 150 is depicted, the user may send and receive information to and from the system server 110, institutional database 120, and/or the terminal 140 on multiple user devices 150 (e.g., initially reporting the error on a mobile phone, and following up via a web portal accessed on a personal computer or tablet).

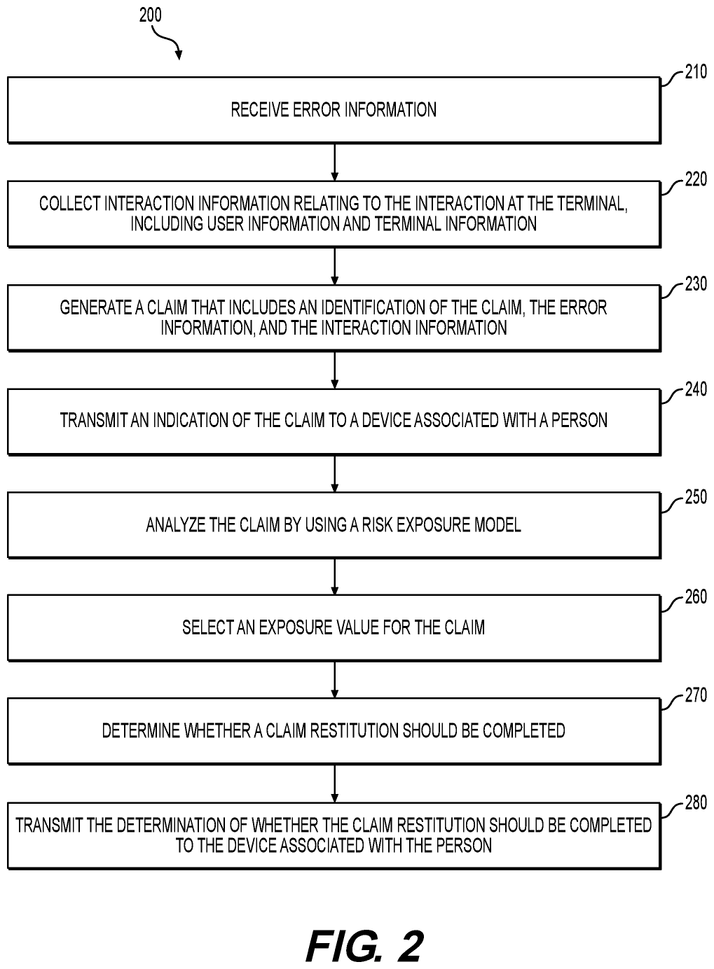

FIG. 2 depicts a flowchart illustrating a method 200 for resolving ATM transaction errors, according to one or more embodiments of the present disclosure. The method 200 may be performed by one or more of the devices that comprise the system environment 100, for example and not limitation, by system server 110 or a combination of system server 110, institutional database 120, and/or terminal 140.

Method 200 may begin at step 210 with the receipt of error information at system server 110, such as from terminal 140. This information can include, for example and not limitation, error codes, terminal identification, user identification, information regarding the desired transaction, and/or sensor information regarding dispersed/received funds and/or card capture. According to some embodiments of the present disclosure, this error information may be automatically and securely sent in response to a triggering event at the terminal 140, for example, processor 141 detecting that an error or malfunction has or may have occurred. In some embodiments, some or all of the error information may be received from user device 150. For example, terminal users may suspect or observe that an error has occurred (even if processor 141 of terminal 140 has not detected any error), and the user may use user device 150 to provide error information, including an amount in dispute, to system server 110 and/or institutional database 120.

Regardless of the source, upon receipt of the error information, at step 220, system server 110 may collect and organize interaction information relating to the terminal transaction that resulted in the error. For example, the error information received at step 210 may provide an account number, but not a user's name or contact information. In some situations contemplated by the present disclosure, the received error information may include user-provided information regarding the location of the terminal accessed, but not a specific terminal identification number or error code. It may also be the case that, due to differences between terminal manufacturers and/or terminal software, the error information received may be in various formats. In these situations, or in other situations contemplated by this disclosure, system server 110 may obtain, combine, secure, and organize the information available from one or more sources including terminal 140, user device 150, and institutional database 120. System server 110 may also review the information obtained to determine if the information is sufficient for the claim to be adjudicated, or if additional information may be necessary.

In situations when additional information is necessary, system server 110 may request additional information from the user, for example, via user device 150. For example, when error information is received from terminal 140, the error information may reflect that there was a failure during an interaction (e.g., a currency deposit), but terminal 140 may not have sufficient information to be aware of, for example, the amount in dispute. System server 110 may determine that this information is absent from the error information, and may transmit a secure request to user device 150 so that the user can provide and/or verify the amount in dispute and/or other error information.

Having obtained and organized the available information, at step 230, system server 110 can generate a claim that includes information including user information and terminal information. This claim may be, for example, a file or file folder in an institutional system, and may be associated with a claim number or other identifier. Claim generation can enable the error and the resolution status to be tracked, updated, and referenced throughout the remainder of the process. System server 110 may generate the claim and store it, for example, in memory 114 of the system server or memory 124 of the institutional database.

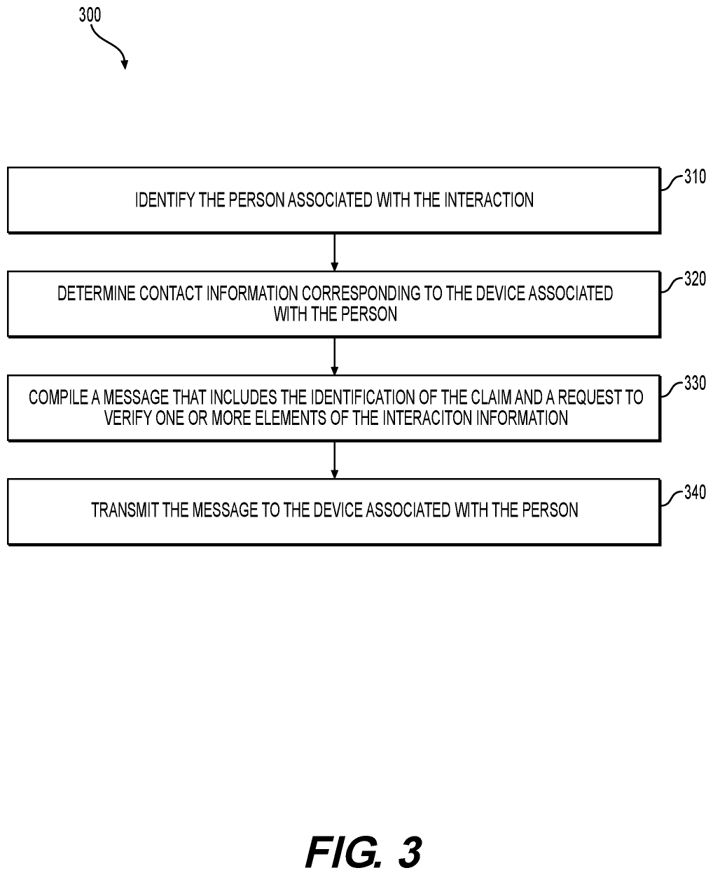

Once the claim is generated, at step 240, system server 110 may transmit an indication that the claim has been created, among other relevant information or requests for information, to user device 150 corresponding to the person conducting the terminal transaction when the error occurred. Notifying the user of the claim creation and a claim number may provide additional transparency and permit the user to track the claim status, provide any additional information, and/or promptly access any determinations provided. An exemplary method for transmitting an indication that the claim has been created is depicted in FIG. 3.

Method 300 may begin at step 310 with an identification of the person associated with the interaction at an ATM that resulted in an error. Once the person is identified, at step 320, the system server may determine contact information for that person, for example by referencing institutional database 120. The contact information may be of any suitable type including, for example and not limitation, a phone number, an email address, and/or a mobile application username.

With the person identified and the contact information determined, at step 330, a message including an identification of the claim may be compiled. The message may include a request to verify one or more elements of the interaction information in order to, for example, confirm that the user was the person involved in the transaction. Exemplary interaction information that may be used for verification include the location of the terminal, the amount of the interaction, the account or card used, and/or error information displayed by the terminal to the user during the transaction error.

Once compiled, at step 340, the message may be transmitted, using the contact information, to a user device associated with the person involved in the transaction at issue. The message may be sent in a number of suitable ways, including but not limited to, by SMS text message, by email, or via a secure message on an institution specific mobile application. The user can then access the message, and verify any information as requested, via the user device.

Returning to FIG. 2, once a claim has been generated and the person notified, at step 250, the claim may be analyzed using a risk exposure model. In some embodiments in accordance with the present disclosure, the risk exposure model may be created using machine learning principles applied to data relating to previous terminal error claims and the outcomes of those claims. In some embodiments in accordance with the present disclosure, the risk exposure model can be created based on information from ATM manufacturers and/or risk analysis experts. Factors that may be used in the risk analysis model may include the amount in dispute, the person's history with the institution, the terminal or terminal manufacturer's history of errors, the amount of detail available regarding the error, the type of error, how the error information was received, the location of the terminal, or other such factors. Once created, the risk analysis model may also be updated on a periodic or rolling basis, as additional claims are investigated and resolved. The analysis may be conducted using suitable methods, for example, a comparison between the claim at issue and similar past claims or a score-based evaluation that attempts to quantify the risk factors associated with the elements of the claim.

As used herein, a “machine learning model” is a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

Based on the results of that analysis, at step 260, an exposure value may be selected for the claim. The exposure value may be, for example, normalized on a scale, or generated as a raw numerical score.

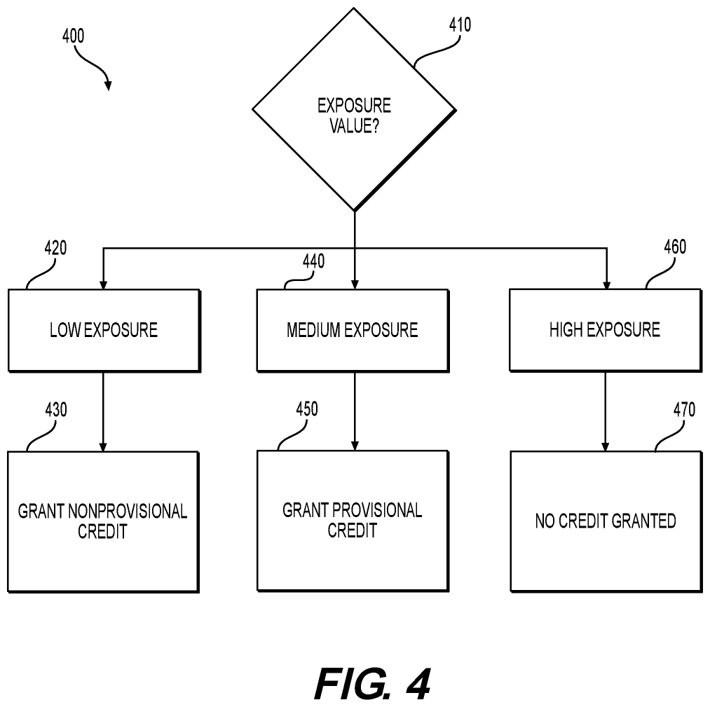

Based on the exposure value, at step 270, a determination may be made as to whether or not a restitution should be provided to the person as a result of the claim. An exemplary method of determining whether a claim restitution should be completed in accordance with the present disclosure is discussed in greater detail below and illustrated in FIG. 4.

As depicted in FIG. 4, method 400 can begin at, step 410, with the exposure value determined in step 260. The exposure value may then be classified, for example, as belonging in a low, medium, or high risk exposure category. In the event that the exposure value is low, as at step 420, the method may continue to step 430 and grant claim restitution to the person as a nonprovisional credit. This allows the person to be made whole for the terminal error, and allows the institution to consider the claim to be finally adjudicated, thereby conserving resources for other claims such as higher-risk claims. In the event that the risk exposure value is classified in the medium exposure category, as at step 440, the method may continue to step 450 and decide to grant claim restitution to the person as a provisional credit. By granting a provisional credit, the person can be made whole while any further processing or auditing can continue to be conducted by the institution. In the event that the risk exposure value is high, as at step 460, the method may continue to step 470 and not grant any claim restitution to the person (e.g., neither as a provisional nor nonprovisional credit) pending additional claim processing. This safeguards the resources from being credited for claims based on errors that are unlikely to be resolved in favor of the person conducting the terminal transaction.

Returning to FIG. 2, at step 280, the determination regarding nonprovisional, provisional, or no credit may be transmitted to the user device associated with the person conducting the terminal transaction when the error occurred. Prompt resolution and communication regarding errors and claims for restitution may have significant positive impacts on user satisfaction and compliance with regulations governing error resolution.

Accordingly, methods and systems in accordance with the present disclosure may contribute to faster, more accurate claim resolution that may be both automatically initiated and communicated to the person involved in the transaction resulting in the error. Considering the resources at stake for both the institution and the institution's user, the amount of information to be collected, and the great many factors involved in the risk evaluation and/or claim resolution, methods and systems in accordance with the present disclosure may provide a faster processing and response speed, a lower cost of resolution, and/or an increased accuracy of the resolution of restitution claims resulting from ATM errors.

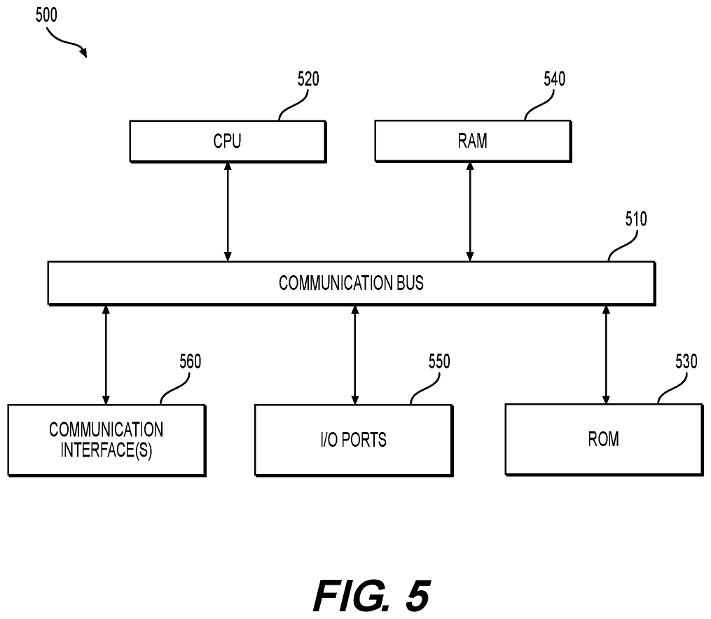

FIG. 5 depicts an example system that may execute techniques presented herein. FIG. 5 is a simplified functional block diagram of a computer that may be configured to execute techniques described herein, according to exemplary embodiments of the present disclosure. Specifically, the computer (or “platform” as it may not be a single physical computer infrastructure) may include a data communication interface 560 for packet data communication. The platform may also include a central processing unit 520 (“CPU”), in the form of one or more processors, for executing program instructions. The platform may include an internal communication bus 510, and the platform may also include a program storage and/or a data storage for various data files to be processed and/or communicated by the platform such as ROM 530 and RAM 540, although the system 500 may receive programming and data via network communications. The system 500 also may include input and output ports 550 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of securely analyzing an error in an interaction between a person and a terminal, comprising:
receiving error information indicative of the error;
collecting interaction information relating to the interaction at the terminal, the interaction information including user information and terminal information;
generating a claim that includes an identification of the claim, the error information, and the interaction information;
transmitting an indication of the claim to a device associated with the person;
analyzing the claim by using a risk exposure model;
selecting, using the analysis of the claim, an exposure value for the claim;
determining, based at least in part on the exposure value, whether a claim restitution should be completed; and
transmitting, to the device associated with the person, the determination of whether the claim restitution should be completed.

2. The method of claim 1, wherein the error information is generated by the terminal in response to a malfunction.

3. The method of claim 1, wherein collecting interaction information includes:
obtaining at least a first portion of the interaction information from the terminal; and
obtaining at least a second portion of the interaction information from a server associated with an institution related to the interaction.

4. The method of claim 1, wherein transmitting the indication of the claim comprises:
identifying the person associated with the interaction;
determining contact information corresponding to the device associated with the person; and
transmitting, to the device associated with the person, a message that includes the identification of the claim.

5. The method of claim 4, wherein the message further includes a request to verify one or more elements of the interaction information.

6. The method of claim 1, wherein analyzing the claim comprises:
evaluating one or more elements of the claim, wherein the one or more elements of the claim include an amount in dispute, an interaction history associated with the person, and the error information; and
comparing one or more elements of the claim with the risk exposure model.

7. The method of claim 1, further comprising:
classifying the exposure value as belonging in one category selected from a group consisting of: low exposure, medium exposure, and high exposure.

8. The method of claim 7, wherein determining whether a claim restitution should be completed comprises:
in response to the exposure value being classified as low exposure, deciding that a nonprovisional credit should be granted;
in response to the exposure value being classified as medium exposure, deciding that a provisional credit should be granted; and
in response to the exposure value being classified as high exposure, deciding that no credit should be granted.

9. The method of claim 1, further comprising:
verifying whether the interaction information is sufficient for the claim to be adjudicated, wherein the sufficiency is determined based at least in part on the error information; and
in response to determining that the interaction information is sufficient, transmitting the claim to an entity associated with an institution related to the interaction for adjudication.

10. The method of claim 1, wherein transmitting the determination of whether the claim restitution should be completed includes providing a claim determination and a status of the claim restitution.

11. A system for securely resolving an error in an interaction, the system comprising:
a terminal for facilitating an interaction with a person;
a system memory storing instructions; and
a system processor executing the instructions to perform a process including:
receiving error information indicative of the error;
collecting interaction information relating to the interaction at the terminal, the interaction information including user information and terminal information;
generating a claim that includes an identification of the claim, the error information, and the interaction information;
transmitting an indication of the claim to a device associated with the person;
analyzing the claim by using a risk exposure model;
selecting, using the analysis of the claim, an exposure value for the claim;
determining, based at least in part on the exposure value, whether a claim restitution should be completed; and
transmitting, to the device associated with the person, the determination of whether the claim restitution should be completed.

12. The system of claim 11, wherein the error information is generated by the terminal in response to a malfunction.

13. The system of claim 11, wherein collecting interaction information comprises:
receiving at least a first portion of the interaction information from the terminal; and
receiving at least a second portion of the interaction information from a server associated with an institution related to the interaction.

14. The system of claim 11, wherein transmitting the indication of the claim comprises:
identifying the person associated with the interaction;
determining contact information corresponding to the device associated with the person; and
transmitting, to the device associated with the person, a message that includes the identification of the claim.

15. The system of claim 14, wherein the message further includes a request to verify one or more elements of the interaction information.

16. The system of claim 11, wherein analyzing the claim comprises:
evaluating one or more elements of the claim, wherein the one or more elements of the claim include an amount in dispute, an interaction history associated with the person, and the error information; and
comparing one or more elements of the claim with the risk exposure model.

17. The system of claim 11, further comprising:
classifying the exposure value as belonging in one category selected from a group consisting of: low exposure, medium exposure, and high exposure.

18. The system of claim 17, wherein determining whether a claim restitution should be completed comprises:
in response to the exposure value being classified as low exposure, deciding that a nonprovisional credit should be granted;
in response to the exposure value being classified as medium exposure, deciding that a provisional credit should be granted; and
in response to the exposure value being classified as high exposure, deciding that no credit should be granted.

19. The system of claim 11, wherein transmitting the determination of whether the claim restitution should be completed includes providing a claim determination and a status of the claim restitution.

20. A non-transitory computer-readable medium storing instructions that, when executed by a processor, cause the processor to perform a method, the method comprising:
receiving error information indicative of an error in an interaction between a person and a terminal, wherein the error information is generated by the terminal in response to a malfunction;
collecting interaction information relating to the interaction at the terminal, the interaction information including user information and terminal information, and wherein at least a first portion of the interaction information is collected from the terminal and at least a second portion of the interaction information is collected from a server associated with an institution related to the interaction;
generating a claim that includes an identification of the claim, the error information, and the interaction information;
transmitting an indication of the claim to a device associated with the person;
analyzing the claim by using a risk exposure model, wherein the analysis of the claim includes evaluating one or more elements of the claim, wherein the one or more elements of the claim include an amount in dispute, an interaction history associated with the person, and the error information;
selecting, using the analysis of the claim, an exposure value for the claim;
determining, based at least in part on the exposure value, whether a claim restitution should be completed; and
transmitting, to the device associated with the person, the determination of whether the claim restitution should be completed.
